(19) United States
(12) Patent Application Publication
(10) Pub. No.: US 2015/0207451 A1
(43) Pub. Date: Jul. 23, 2015

(54) PORTABLE SOLAR PANEL KIT

(71) Applicant: Enphase Energy, Inc., Petaluma, CA (US)

(72) Inventors: John C. Patton, Roseville, CA (US); Eric Hafter, Sacramento, CA (US); Todd Lindstrom, Auburn, CA (US); Martin Fornage, Petaluma, CA (US)

(21) Appl. No.: 14/587,606

(22) Filed: Dec. 31, 2014

Related U.S. Application Data
(60) Provisional application No. 61/923,112, filed on Jan. 2, 2014.
(60) Provisional application No. 62/021,918, filed on Jul. 8, 2014.

(51) Int. Cl. H02S 10/40; H02S 40/32

(52) U.S. Cl. CPC H02S 10/40; H02S 20/32; H02S 40/32

(57) ABSTRACT

A portable solar panel kit is provided herein. In one embodiment, the portable solar panel kit comprises at least one encasement having a solar panel rotatably coupled to and disposed within the at least one encasement; and a power converter coupled to a backside of the solar panel, wherein the solar panel is moveable between a first position in which the solar panel is parallel to the at least one encasement, and a second position, in which the solar panel is disposed at a predetermined angle to the at least one encasement.

### CROSS-REFERENCE TO RELATED APPLICATIONS

This application claims benefit of U.S. provisional patent application Ser. Nos. 61/923,112, filed Jan. 2, 2014, and 62/021,918, filed Jul. 8, 2014, which are herein incorporated in their entireties by reference.

### BACKGROUND OF THE INVENTION

1. Field of the Invention

Embodiments of the present disclosure relate generally to solar panels, and, in particular, to a portable solar panel kit.

2. Description of the Related Art

Renewable energy is an important and growing field, particularly in connection with solar energy. Various systems have been implemented to harness solar energy, including solar panels installed on roofs and in other locations. However, many current solar panel applications are not easily transportable. In fact, such systems are often large and cumbersome to set up, and are not user-friendly.

Therefore, there is a need in the art for a portable solar panel kit that is simple to set up.

### SUMMARY OF THE INVENTION

Embodiments of the present invention generally relate to a portable solar panel kit substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic side view of a portable solar panel kit in accordance with one or more embodiments of the present invention;

FIG. 2 is a top view of part of a portable solar panel kit in accordance with one or more embodiments of the present invention;

FIG. 3 is a top view of an encasement of a portable solar panel kit in accordance with one or more embodiments of the present invention;

FIGS. 4A-4C are cross-sectional views illustrating various positions of a portable solar panel kit in accordance with one or more embodiments of the present invention; and

FIGS. 5A-5C are cross-sectional views illustrating various positions of a portable solar panel kit in accordance with one or more embodiments of the present invention.

### DETAILED DESCRIPTION

Embodiments of a portable solar panel kit are provided herein. The portable solar panel kit is easily transportable; for example, a user can hand-carry the portable solar panel kit to a desired location. The portability of the portable solar panel kit of the present invention advantageously allows for deployment of at least one solar panel at a particular location, such as a user's place of residence, to provide solar power thereto. Because of the simplicity of the construction of the portable solar panel kit, the user is able to deploy the kit with relative ease.

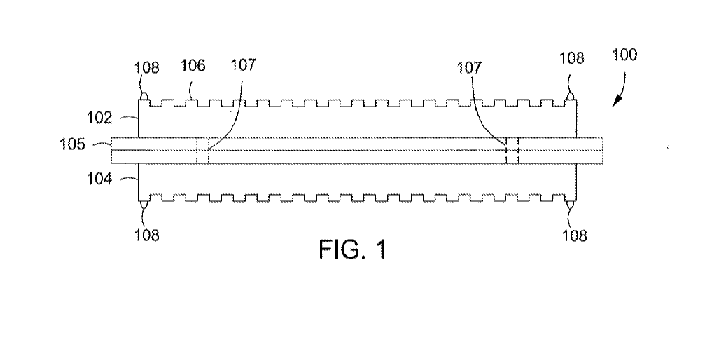

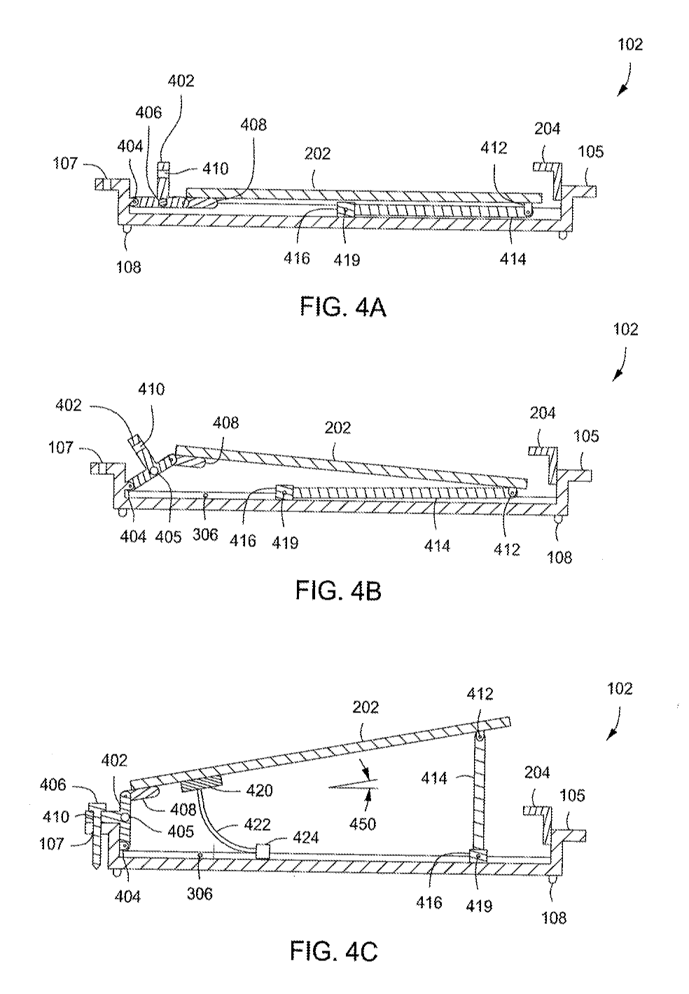

FIG. 1 is a schematic side view of a portable solar panel kit 100 in accordance with one or more embodiments of the present invention. The portable solar panel kit 100 includes at least one encasement 102/104. In some embodiments, the portable solar panel kit 100 may include two encasements: a first encasement 102 and a second encasement 104 temporarily coupled together via any conventional means (e.g., a nylon strap) during transport. However, the portable solar panel kit 100 may include any number of encasements. Because the first and second encasements 102, 104 are substantially identical, and only the features of the first encasement 102 (hereinafter “the encasement 102”) are labeled in FIGS. 1-5 and will be described for clarity and conciseness. The following description applies to both the first and second encasements 102, 104. The encasement 102 may include a ledge 105 having a pair of lock pin holes 107, which will be described below with respect to FIGS. 4A-C.

The encasement 102 may further include a plurality of ribs 106 on which the encasement 102 rests while in use. In some embodiments, one or more of the plurality of ribs 106 may include a rubber element 108 to support the encasement 102 while deployed and prevent movement of the encasement 102 caused, for example, by wind. In some embodiments, the plurality of ribs may additionally or alternatively be textured to prevent movement of the encasement 102 caused, for example, by wind. The plurality of ribs 106 serve to keep the encasement 102 off of a supporting surface to allow air to pass between the ribs (below the encasement 102) to prevent any mold or other vegetation from forming beneath the encasement 102. In some embodiments, the plurality of ribs 106 supports the encasement 102 about 0.25 inches off of the ground, although in other embodiments it may be more or less.

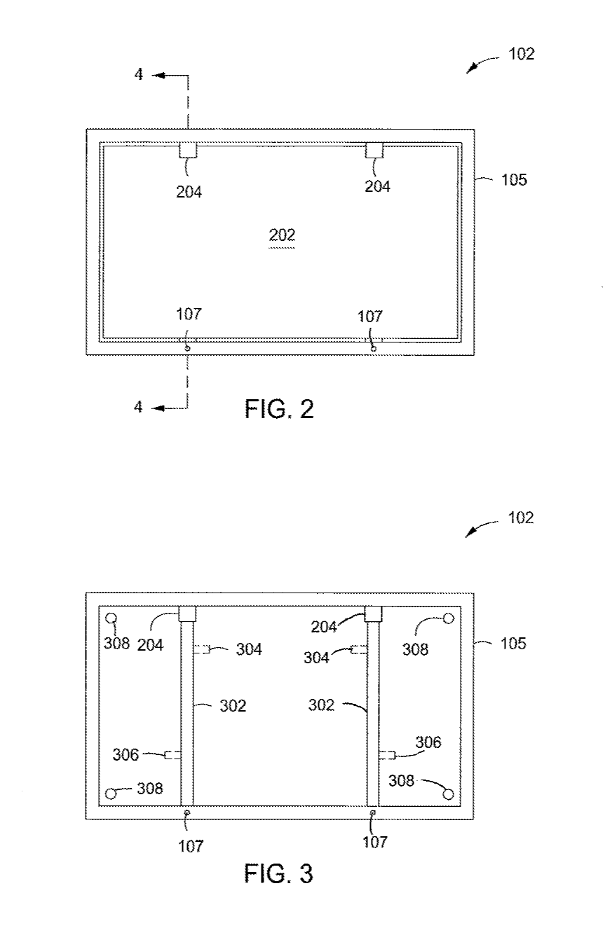

FIG. 2 is a top view of the encasement 102 of the portable solar panel kit 100 containing a photovoltaic module (i.e., a solar panel) 202 in accordance with one or more embodiments of the present invention. In some embodiments, the encasement 102 includes a plurality of retaining tabs 204 that retain the solar panel 202 in a first position within the encasement 102. The plurality of retaining tabs 204 prevent movement of the solar panel 202 in a direction perpendicular to the encasement 102. The solar panel 202 may be in the first position during, for example, transport, storage, and the like. A plurality of pivot arms 402 (shown in FIGS. 4A-C and discussed below) also assist in retaining the solar panel 202 in the first position.

FIG. 3 is a top view of the encasement 102 without the solar panel 202 in accordance with one or more embodiments of the present invention. In some embodiments, the encasement 102 may be formed of a polymer (e.g., plastic) and may be coated with a material that prevents degradation of the encasement 102 from forces of nature (e.g., rain, snow, etc.). In some embodiments, the encasement 102 may be formed of a material that prevents degradation of the encasement 102 from forces of nature (e.g., rain, snow, etc.) without the need for an additional coating.

In some embodiments, the encasement 102 includes a plurality of slots 302 extending between the retaining tabs 204 and the lock pin holes 107. The plurality of slots 302 are configured to allow only linear movement of a corresponding plurality of sliding blocks 416 (described below with respect to FIG. 4). Each of the plurality of slots 302 may include a retaining hole 306 and a feature 304, whose functions will be described in more detail below. In some embodiments, the encasement 102 may include one or more drainage holes 308 to allow any water that has accumulated in the encasement 102 to drain out of the encasement 102. In some embodiments, the encasement 102 may further include a plurality of ribs (not shown) protruding towards the solar panel 202 to increase the rigidity of the encasement 102.

FIGS. 4A-4C are cross-sectional views taken along line 4-4 in FIG. 2 illustrating various positions of the solar panel 202 in accordance with one or more embodiments of the present invention. In some embodiments, a pivot arm 402 and a swinging arm 414 are coupled to a backside of the solar panel 202. Although the following discussion describes one pivot arm 402 and one swinging arm 414, it should be noted that the encasement 102 includes a plurality of pivot arms 402 and a plurality of swinging arms 414 corresponding to the plurality of slots 302 of the encasement 102 (i.e., one pivot arm 402 and one swinging arm 414 per each slot 302).

The pivot arm 402 is rotatably coupled to an inner surface of the encasement 102 via a hinge 404 to allow the pivot arm 402 to rotate. The pivot arm 402 is also rotatable coupled to a backside of the solar panel 202 via a hinge element 408. The hinge element 408 is fixedly coupled to the backside of the solar panel 202 and rotatably coupled to the pivot arm 402. The pivot arm 402 includes a first hole 405 and a second hole 410. In the first position (shown in FIG. 4A), the first hole 405 is aligned with the retaining hole 306 (shown in FIGS. 4B and 4C). To fix the solar panel 202 in the first position (FIG. 4A), a locking pin 406 is inserted through the first hole 405 and extends through the retaining hole 306. The locking pin 406 must be removed to move the solar panel 202. In the second position (shown in FIG. 4C), the second hole 410 is aligned with the lock pin hole 107. To fix the solar panel 202 in the second position (FIG. 4C), the locking pin 406 is inserted through the second hole 410 and extends through the lock pin hole 107. In the second position, the solar panel 202 is disposed at a predetermined angle 450 with respect to the encasement 102. The predetermined angle 450 may be between, for example, 5°-20°. In some embodiments, the predetermined angle 450 may be more or less than 5°-20°. In some embodiments, the predetermined angle 450 is 20°. In some embodiments, an angle between the solar panel 202 and the encasement 102 may be adjustable so that the solar panel 202 is disposed at any desired angle.

The swinging arm 414 is rotatably coupled at a first end to the backside of the solar panel 202 via a hinge 412 and at a second end to a sliding block 416. The sliding block 416 is disposed within and moves along the slot 302 during movement of the solar panel 202 between the first and second positions. The sliding block 416 includes at least one protrusion 419 that engages the feature 304 of the encasement 102 when the solar panel 202 is in the second position to fix the solar panel 202 in the second position. In some embodiments, the at least one protrusion 419 may be a roller.

To deploy the portable solar panel kit 100, the locking pin 406 must first be removed from the first hole 405 and the retaining hole 306. Subsequently, the pivot arm 402 is pulled away from the encasement (FIGS. 4B-4C) until the second hole 410 is aligned with the lock pin hole 107, which pulls the solar panel 202 out from under the retaining tab 204. The locking pin 406 is then inserted through the second hole 410 and the lock pin hole 107. Finally, the solar panel 202 is lifted from a side opposite the pivot arm 402 until the sliding block 416 moves to a position in which the at least one protrusion 419 engages the corresponding feature 304 of the encasement 102. In the second position, the swinging arm 414 is perpendicular to the encasement 102.

In some embodiments, the pivot arm 402 may include a protrusion (not shown) that extends through a corresponding hole (not shown) in the encasement 102 to retain the solar panel 202 in the first position. In such embodiments, the plurality of retaining tabs 204 may be eliminated. Although FIGS. 4A-4C depict specific locations and orientations of the first hole 405, the second hole 410, the retaining hole 306, and the lock pin hole 107, these holes may be disposed in alternative positions and orientations to facilitate the locking of the solar panel 202 in the first position and the second position. In some embodiments, a torsion spring (not shown) may be disposed between the pivot arm 402 and the hinge element 408 to bias the solar panel 202 towards the second position.

A power converter 420 is coupled to a backside of the solar panel 202 to convert the power generated by the solar panel (DC) to power usable at a user's location, such as a residence or workplace. In some embodiments the generated power may be DC power; in other embodiments, the generated power may be AC power. The power converter 420 is coupled to a plug 424 via a wire 422. In some embodiments, the power converter 420 may alternatively be separate from the solar panel 202 and may be plugged into a receptacle extending from the solar panel 202. As noted above, although the above-described components have been described in a singular manner, each of the encasements 102, 104 include a plurality of these components. For example, each encasement 102,104 includes a plurality pivots arms 402, swinging arms 414, sliding blocks 416, locking pins 406, etc.

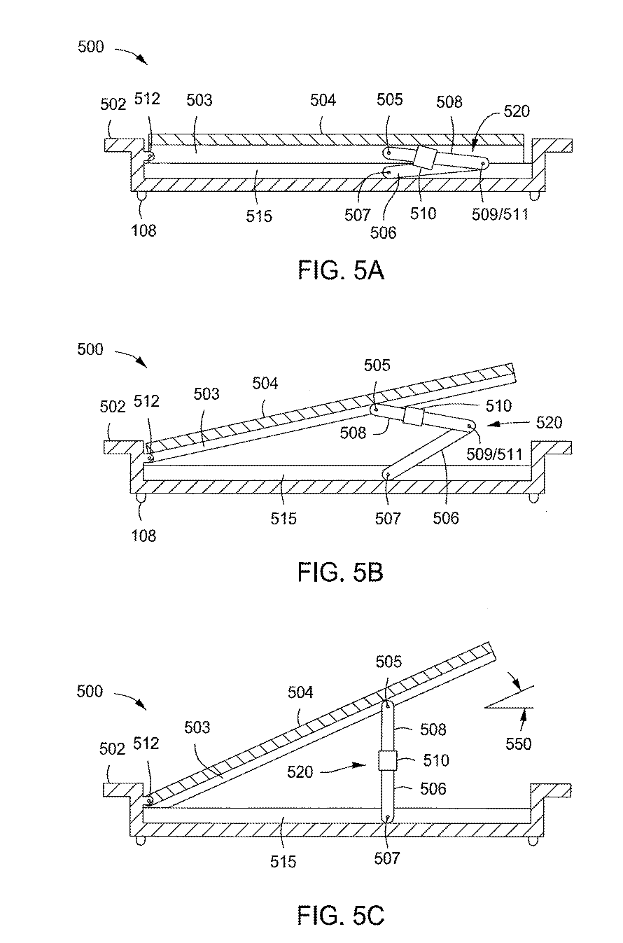

FIGS. 5A-5C are cross-sectional views illustrating various positions of a portable solar panel kit 500 in accordance with one or more embodiments of the present invention. The portable solar panel kit 500 includes a solar panel 504 coupled to an encasement 502 via a hinge element 512 and a scissor arm assembly 520. The encasement 502 is substantially similar to the encasement 102 and may similarly include a plurality of ribs and rubber elements similar to those of the encasement 102. The scissor arm assembly 520 may include a first arm 506 and a second arm 508. The first arm 506 is rotatably coupled to the encasement 502 at a first end 507, for example, a hinge element and to the second arm 508 at a second end 509 opposite the first end 507. The second arm 508 is rotatably coupled to a backside of the solar panel 504 via, for example, a hinge element at a third end 505 and to the first arm 506 at a fourth end 511. The scissor arm assembly 520 further includes a collar 510 movably disposed on the second arm 508. Alternatively, the collar 510 may be movably disposed on the first arm 506.

In the first position (FIG. 5A), the first arm 506 is disposed in a slot 515 formed in the encasement 502, the second arm 508 is disposed in an opening 503 behind the solar panel 504, and the collar 510 is disposed on the second arm 508 between the third and fourth ends 505, 511. The first arm 506 is rotatably coupled to opposing walls of the slot 515 at the first end 507. The second arm 508 is rotatably coupled to opposing walls of the opening 503 at the third end 505. In the second (deployed) position (FIG. 5C), the first and second arms 506, 508 extend perpendicularly to the encasement 502 and the collar 510 is disposed around the second and fourth ends 509, 511 to prevent movement of the first and second arms 506, 508. A width of the first arm 506 may be greater than an inner width of the collar 510 to prevent the collar 510 from sliding down the first arm 506 while in the second position. Additionally or alternatively, other techniques may be used for retaining the collar 520 around the second and fourth ends 509, 511.

To deploy the portable solar panel kit 500, the solar panel 504 is lifted at an end opposite the hinge element 512. As solar panel 504 is lifted (FIG. 5B), the first and second arms 506, 508 move towards vertical position in which the arms are collinear and the collar 510 slides down the second arm 508 towards the first arm 506. When the solar panel 504 reaches the second position (FIG. 5C), the width of the first arm 506 prevents the collar 510 from sliding down any further and the arms 506, 508 are locked in the second position. In other embodiments, other techniques may be used for locking the arms 506, 508 in place in the second position. In the second position, the solar panel 504 is at a predetermined angle 550 with respect to the encasement 502. The predetermined angle 550 may be between 5°-20°. In some embodiments, the predetermined angle 550 may be more or less than 5°-20°. In some embodiments, the predetermined angle is 20°. In some embodiments, an angle between the solar panel 504 and the encasement 502 may be adjustable so that the solar panel 504 is disposed at any desired angle. Similar to the solar panel kit 100, a power converter (not shown in FIG. 5) may be coupled to a backside of the solar panel 504 to convert the power generated by the solar panel 504 to power usable at a user's location, such as a residence or workplace.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A portable solar panel kit, comprising:
at least one encasement having a solar panel rotatably coupled to and disposed within the at least one encasement; and
a power converter coupled to a backside of the solar panel,
wherein the solar panel is moveable between a first position in which the solar panel is parallel to the at least one encasement, and a second position, in which the solar panel is disposed at a predetermined angle to the at least one encasement.

2. The portable solar panel kit of claim 1, wherein the solar panel is coupled to the at least one encasement via a plurality of pivot arms and a corresponding plurality of swinging arms.

3. The portable solar panel kit of claim 2, wherein each of the plurality of swinging arms is rotatably coupled to the solar panel at a first end and to a corresponding plurality of sliding blocks at a second end opposite the first end.

4. The portable solar panel kit of claim 3, wherein the plurality of sliding blocks are disposed in a corresponding plurality of slots formed in the at least one encasement.

5. The portable solar panel kit of claim 4, wherein the plurality of slots are configured to allow linear movement of the plurality of sliding blocks.

6. The portable solar panel kit of claim 5, further comprising:
a plurality of retaining tabs disposed in the at least one encasement to prevent movement of the solar panel in a direction perpendicular to the at least one encasement; and
a plurality of locking pins corresponding to the plurality of pivot arms to lock the plurality of pivot arms in one of the first position or the second position.

7. The portable solar panel kit of claim 1, wherein the at least one encasement is formed of a polymer.

8. The portable solar panel kit of claim 1, wherein the at least one encasement includes two encasements, each having a corresponding solar panel.

9. The portable solar panel kit of claim 1, wherein the at least one encasement includes a plurality of protrusions on a backside of the encasement on which the encasement rests.

10. The portable solar panel kit of claim 1, wherein the solar panel is coupled to the at least one encasement via a plurality of scissor arm assemblies.

11. The portable solar panel kit of claim 10, wherein each of the plurality of scissor arm assemblies comprises:
a first arm having a first end and a second end, wherein the first arm is rotatably coupled to the at least one encasement at the first end;
a second arm having a third end and a fourth end, wherein the second arm is rotatably coupled to the solar panel at the third end and to the second end of the first arm at the fourth end; and
a collar movably disposed on the second arm,
wherein the collar is disposed between the third end and the fourth end in the first position, and
wherein the collar is disposed around the second end and the fourth end in the second position to prevent movement of the first arm and the second arm.

12. The portable solar panel of claim 11, wherein a width of the first arm is greater than an inner width of the collar to prevent the collar from sliding down the first arm in the second position.

13. The portable solar panel of claim 1, wherein, in the first position, the solar panel is disposed entirely within the at least one encasement, and wherein the predetermined angle is between 5 and 20 degrees.

14. A portable solar panel kit, comprising:
a first encasement having a first solar panel rotatably coupled to and disposed within the first encasement;
a second encasement coupled to the first encasement and having a second solar panel rotatably coupled to and disposed within the second encasement; and
a first power converter coupled to the first solar panel; and
a second power converter coupled to the second solar panel,
wherein the first solar panel is moveable between a first position in which the first solar panel is parallel to the first encasement, and a second position, in which the first solar panel is disposed at a predetermined angle to the first encasement, and
wherein the second solar panel is moveable between a third position in which the second solar panel is parallel to the second encasement, and a fourth position, in which the second solar panel is disposed at the predetermined angle to the second encasement.

15. The portable solar panel kit of claim 14, wherein the first solar panel is coupled to the first encasement via a first plurality of pivot arms and a corresponding first plurality of sliding arms, and wherein the second solar panel is coupled to the second encasement via a second plurality of pivot arms and a corresponding second plurality of sliding arms.

16. The portable solar panel kit of claim 15, wherein each of the first plurality of pivot arms is rotatably coupled to the first solar panel at a first end and to a corresponding first plurality of sliding blocks at a second end opposite the first end, and wherein each of the second plurality of pivot arms is rotatably coupled to the second solar panel at a third end and to a corresponding second plurality of sliding blocks at a fourth end opposite the third end.

17. The portable solar panel kit of claim 16, wherein the first plurality of sliding blocks are disposed in a corresponding first plurality of slots formed in the first encasement, and wherein the second plurality of sliding blocks are disposed in a corresponding second plurality of slots formed in the second encasement.

18. The portable solar panel kit of claim 17, wherein the first plurality of slots are configured to allow linear movement of the first plurality of sliding blocks, and wherein the second plurality of slots are configured to allow linear movement of the second plurality of sliding blocks.

19. The portable solar panel kit of claim 18, further comprising:
a first plurality of retaining tabs disposed in the first encasement to prevent movement of the first solar panel in a direction perpendicular to the first encasement;
a second plurality of retaining tabs disposed in the second encasement to prevent movement of the second solar panel in a direction perpendicular to the second encasement;
a first plurality of locking pins corresponding to the first plurality of pivot arms and inserted into the first plurality of pivot arms to lock the first plurality of pivot arms in one of the first position or the second position; and
a second plurality of locking pins corresponding to the second plurality of pivot arms and inserted into the second plurality of pivot arms to lock the second plurality of pivot arms in one of the third position or the fourth position.

20. The portable solar panel kit of claim 14, wherein the first solar panel is coupled to the first encasement via a first plurality of scissor arm assemblies, and wherein the second solar panel is coupled to the second encasement via a second plurality of scissor arm assemblies.
